(19) United States
(12) Patent Application Publication
(10) Pub. No.: US 2007/0280137 A1
(43) Pub. Date: Dec. 6, 2007

(54) Creation Of Non-Wired Communication Network, By Determining Local Topology Information From The Identifiers Of Communication Appliances

(76) Inventors: Michael Bahr, Munchen (DE); Mathias Kutschenreuter, Munchen (DE)

Correspondence Address: STAAS & HALSEY LLP, SUITE 700, 1201 NEW YORK AVENUE, N.W., WASHINGTON, DC, 20005, US

(21) Appl. No.: 11/660,542

(22) PCT Filed: Aug. 2, 2005
(86) PCT No.: PCT/EP05/53763

§ 371 Date: Feb. 20, 2007

(30) Foreign Application Priority Data
Aug. 18, 2004 (DE) 10 2004 040 069.5

(51) Int. Cl. H04L 12/56

(52) U.S. Cl. 370/254

(57) ABSTRACT

In order to create a non-wired network, a first communication appliance is provided with a list of identifiers of other communication appliances with which connections can be established. The first communication appliance determines information on the local topology of the non-wired communication network from the identifiers of the other communication appliances. The first communication appliance establishes a connection with the isolated, thus collected, partial networks and individual communication appliances, and integrates the same into the network.

### CROSS REFERENCE TO RELATED APPLICATIONS

This application is based on and hereby claims priority to Application No. PCT/EP2005/053763 filed on Aug. 2, 2005 and German Application No. 10 2004 040 069.5 filed on Aug. 18, 2004, the contents of which are hereby incorporated by reference.

### BACKGROUND

The present invention relates to a method for creating a non-wireline communications network by determining local topology information from the identification codes of the communications devices.

Wireline network technology for the transmission of data between a plurality of communications devices involves a loss of mobility and therefore also convenience. In contrast, non-wireline network technology allows data to be transmitted over short distances without being subject to mobility limitations. For this purpose the communications devices can connect to one another spontaneously and autonomously.

In a first method, a first communications device is initially provided with a list of the other communications devices to which it can connect. By proceeding step by step in the list or by manual manipulation, the first communications device decides to which other communications device it will make a request for a connection setup.

In a second method (Specification of the Bluetooth System, Version 1.2, Core) for creating a non-wireline network, a distinction is made between a communications control device used for controlling communications, and a communications device which is controlled by the communications control device. In general, two communications control devices or two controlled communications devices cannot connect to each other. As a communications control device can only control a limited number of communications devices, this means that the size of a network is limited by the user capacity of its communications control device. A larger number of communications devices can be achieved by combining individual networks into a larger overall network. There are two possibilities for establishing the necessary bridge connection between two communications control devices. One option is for a device to act as a communications control device in the first network and as a controlled communications device in the second network. Another option is to connect two communications control devices via a controlled communications device. This enables different network topologies to be achieved, such as a tree, chain or mesh topology.

An implementation of a non-wireline network according to the second method at Technion, Israel Institute of Technology in Haifa, requires, at startup of each device, information as to whether it is to be operated as a communications control device or as a controlled communications device. By the positioning and the sequence in which the devices are switched on, various topologies can then be created (http://www-comnet.technion.ac.il/˜cn9wO2). Such a network with a tree topology has been set up at the ETH Zurich (http://www.tik.ee.ethz.ch/˜beutel/bt node.html). The formation algorithm is not known in greater detail.

The disadvantage of these methods is that a communications device wishing to establish a connection has no information at its disposal concerning the local topology of the network. This can result in an individual communications device or entire subnetworks not being incorporated in the overall network. Moreover, the creation of a network can only be achieved statically and does not therefore meet the dynamic requirements for non-wireline transmission using a plurality of communications devices.

### SUMMARY

One possible object of the present invention is therefore to specify a method whereby an overall network encompassing a plurality of communications devices can organize itself and individual communications devices and/or subnetworks not yet connected are incorporated when this network is created.

The inventors propose determining the local topology information. The local topology information is determined from the identification codes of the communications devices. For this purpose a first communications device is given a list of identification codes of at least one second communications device to which a connection is establishable. From the identification codes, further communications devices that are connected to the second communications device identified in the list can be determined. The first communications device requests a connection setup to at least one second communications device which is identified in the list of identification codes and has no direct or indirect connection to the first communications device or, according to the local information from the list of identification codes, has no direct or indirect connection to the first communications device. If the request is successful, a connection setup takes place.

Without limiting the generality of this term, communications devices are to be understood, for example, as PCs and computer peripherals, mobile devices (laptops, handheld PCs, PDAs), telecommunications devices (mobile phones, ISDN systems), video and TV equipment, audio devices and household appliances (washing machines, refrigerators). Said devices are networkable e.g. using IrDA, Bluetooth or WLAN modules.

According to an advantageous embodiment, a first communications device assigns second communications devices on the basis of their identification codes to, in each case, a group of communications devices which are interconnected. The first communications device request a connection to be set up to at least one second communications device if said second communications device is not assigned to the same group of communications devices as the first communications device. This ensures fast and efficient determination of the local topology information, thereby enabling the network to be quickly created.

According to another advantageous embodiment, the local topology information is determined by a communications control device from the identification codes of communications devices, the term communications devices being used here collectively for communications control devices and controlled communications devices. A first communications control device is given a list of identification codes of at least one second communications device to which a connection is establishable. From the identification codes of the second communications devices, further communications devices can be determined which are connected to the second communications device identified in the list. The first communications control device requests a connection setup to at least one second communications device which is identified in the list of identification codes and which has no direct or indirect connection to the first communications device. If the request is successful, a connection setup takes place.

Without limiting the generality of this term, communications control devices are to be understood, for example, as a master device according to the Bluetooth communications protocol or a primary station according to the IrDA communications protocol. A controlled communications device accordingly corresponds to a slave device according to the Bluetooth protocol and a secondary station according to the IrDA protocol.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 schematically illustrates an exemplary network topology with a plurality of master devices and slave devices,

FIG. 2 schematically illustrates the network topology from FIG. 1 after execution of the algorithm.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

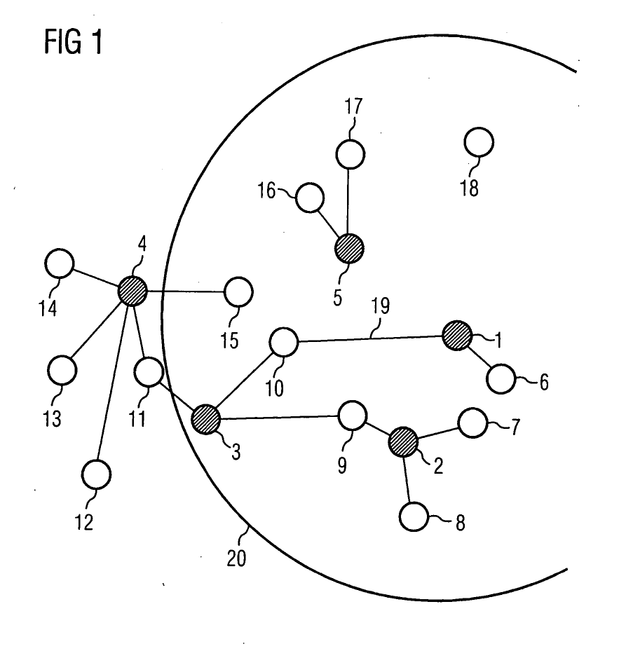

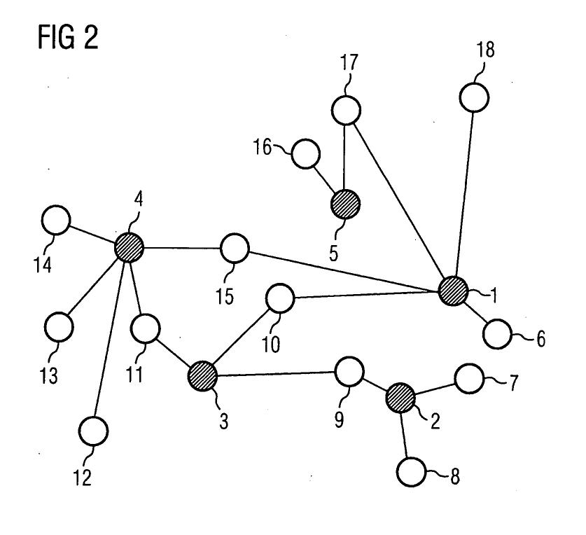

In FIGS. 1 and 2 the five shaded circles symbolize the master devices and the fourteen white circles the slave devices. In this arrangement two master devices or two slave devices cannot connect directly to each other. A connection between two master devices is only possible via a slave device which in this exemplary embodiment can be connected to up to two communications control devices. In general the number of devices which a communications control device can control is limited for technical and/or administrative reasons. In the following description of the exemplary embodiment, “devices” is used as a collective term for master devices and slave devices.

FIG. 1 shows a subnetwork with four master devices 1,2,3,4 and ten slave devices 6,7,8,9,10,11,12,13,14,15, a subnetwork not connected to same comprising one master device 5 and two slave devices 16,17, and an individual slave device 18. The partial circle 20 represents the range of the master device 1. A continuous line 19 symbolizes an existing connection between the devices, in the example for the line 19 a connection between the master device 1 and the slave device 10.

In the identification codes (local names) of the slave devices are contained the identifiers of the master devices to which the slave devices are directly connected. As a first step, the master device 1 is given a list of the devices 6,7,2,8,9,3,10,15,5,16,17,18 within its range.

As additional information, the local name of the slave device 9 contains the identifiers of the master devices 2 and 3 and the slave device 10 the identifiers of the master devices 1 and 3. The local name of the slave device 6 contains the identifier of the master device 1, the local names of the slave devices 7 and 8 the identifier of the master device 2, the local name of the slave device 15 the identifier of the master device 4 and the local names of the slave devices 16 and 17 the identifier of the master device 5.

On the basis of this information, the master device 1 subdivides the devices into three groups, interconnected devices being assigned to the same group in each case. The first group contains the devices 1,6,7,2,8,9,3,10, the second group the devices 5,16,17 and the third group the devices 4,15. The slave device 18 is not connected to any master device and is therefore not assigned to any group.

The first group contains the devices which are connected to the master device 1. The second group has been recognized by the master device 1 as an isolated subnetwork comprising the interconnected devices 5,16,17. The devices 4 and 15 have been assigned by the master device 1 to the third group and are therefore regarded by it as an isolated subnetwork. Because of the limited range of master device 1, only local topology information is available to it. Therefore it is not recognizable to the master device 1 that it is already connected indirectly to the slave device 15 and therefore to the third group.

The master device 1 successfully establishes a connection to slave device 18 in order to incorporate the individual slave device 18 into the network. Master device 1 then successfully establishes a connection to slave device 15 in order to assimilate the subnetwork determined by the master device 1 into the network.

As a final step the master device 1 successfully establishes a connection to slave device 17, which means that all the devices are interconnected and the algorithm is therefore complete.

FIG. 2 shows the network topology from FIG. 1 after the above described algorithm has been executed. It can be seen from FIG. 2 that the individual slave device 18 and the subnetwork comprising the devices 5,16,17 have been incorporated in the network by the master device 1. As the slave device 11 lies outside the range of master device 1, the master device 1 could not determine that it is already connected to the slave device 15 via the master device 4, thereby producing the mesh between the master devices 1,3 and 4. The example shows that the degree of meshing depends on the range of the master device.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. A method for creating a non-wireline communications network, comprising:
providing a first communications device with a list of identification codes of respective second communications devices to which a connection with the first communications device is establishable;
identifying from each identification code all communications devices already connected to each second communications device;
based on the communications devices connected to the second communications device, determining if the second communications device is indirectly connected to the first communications device;
for each second communications device, sending a request for a connection setup, from the first communications device to the second communications device if the second communications device is not directly or indirectly connected to the first communications device; and
setting up a connection if the request is successful.

9. The method as claimed in claim 8, wherein
the first communications device assigns an interconnection group to each second communications device based on the identification code of the second communications device, and
the first communications device sends the request for a connection setup, to the second communications device if the second communications device is not assigned to the same group as the first communications device.

10. The method as claimed in claim 8, wherein
the first communications device assigns an interconnection group to each second communications device based on the identification code of the second communications device, and
the first communications device sends the request for a connection setup, to the second communications device if the second communications device is not assigned to the same group as the first communications device and the second communications device has less than a predetermined number of connections to other communications devices.

11. The method as claimed in claim 8, wherein the first communications device can be connected to no more than a limited number of second communications devices.

12. The method as claimed in claim 8, wherein
the first communications device is a communications control device, and
each communications control device is directly connected to only communications device controlled by the communications control device.

13. The method as claimed in claim 12, wherein
the first and second communications devices are configured according to Bluetooth Core Specification Version 1.2,
each communications control device corresponds to a master and each communications device controlled by a communications control device corresponds to a slave, and
each slave has a local name as its identification code.

14. The method as claimed in claim 8, wherein
the first and second communications devices are configured according to Bluetooth Core Specification Version 1.2,
the first communications device corresponds to a master, and
in case of a connection between first and second masters, the first master acts as a slave in the connection with the second master to form a master/slave bridge between the second master and a slave communications device connected to the first master.

15. The method as claimed in claim 10, wherein the first communications device can be connected to no more than a limited number of second communications devices.

16. The method as claimed in claim 15, wherein
the first communications device is a communications control device, and
each communications control device is directly connected to only communications device controlled by the communications control device.

17. The method as claimed in claim 16, wherein
the first and second communications devices are configured according to Bluetooth Core Specification Version 1.2,
each communications control device corresponds to a master and each communications device controlled by a communications control device corresponds to a slave, and
each slave has a local name as its identification code.

18. The method as claimed in claim 15, wherein
the first and second communications devices are configured according to Bluetooth Core Specification Version 1.2,
the first communications device corresponds to a master, and
in case of a connection between first and second masters, the first master acts as a slave in the connection with the second master to form a master/slave bridge between the second master and a slave communications device connected to the first master.
